(19) United States
(12) Patent Application Publication
(10) Pub. No.: US 2003/0169343 A1
(43) Pub. Date: Sep. 11, 2003

(54) Method, apparatus, and program for processing images

(76) Inventors: Makoto Kagaya, Kanagawa (JP); Takaaki Terashita, Kanagawa (JP)

Correspondence Address: BIRCH STEWART KOLASCH & BIRCH, PO BOX 747, FALLS CHURCH, VA, 22040-0747, US

(21) Appl. No.: 10/378,952

(22) Filed: Mar. 5, 2003

(30) Foreign Application Priority Data
Mar. 5, 2002 (JP) 2002-058165

(51) Int. Cl. H04N 5/225

(52) U.S. Cl. 348/207.1

(57) ABSTRACT

Information representing a position of a main object image pattern, which is embedded in an image represented by an image signal having been acquired with a digital camera, the information having been appended to the image signal, is acquired. A predetermined image region, which contains the main object image pattern, is set on the image and in accordance with the information representing the position of the main object image pattern. The predetermined image region is extracted from the image. The setting of the predetermined image region may be performed also in accordance with information concerning an image-recording magnification ratio at the time of the acquisition of the image signal, which information has been appended to the image signal.

### BACKGROUND OF THE INVENTION

1. Field of the Invention

This invention relates to an image processing method and apparatus, wherein a predetermined image region to be subjected to trimming, combining with a template, or the like, is extracted from an image, which is represented by an image signal having been acquire with a digital camera. This invention also relates to a computer program for causing a computer to execute the image processing method, and a computer readable recording medium, on which the computer program has been recorded.

2. Description of the Related Art

Images, which have been acquired from image recording operations performed with digital electronic still cameras (hereinbelow referred to as the digital cameras), are capable of being recorded as digital image signals on recording media, such as internal memories or IC cards, which are located within the digital cameras. The digital image signals having been recorded on the recording media are capable of being utilized for reproducing the images, which have been acquired from the image recording operations, as visible images by use of printers or monitors. In cases where the images, which have been acquired with the digital cameras, are to be printed, it is desired that the images having image quality as good as the image quality of photographs printed from negative film are capable of being obtained.

In cases where the prints described above are to be obtained, various kinds of image processing, such as image density transform processing, white balance adjustment processing, gradation transform processing, saturation enhancement processing, and sharpness processing, are ordinarily performed on the image signals. In this manner, the image quality of the prints is capable of being enhanced. In order for prints having better image quality to be obtained, a technique for performing appropriate image processing on an image signal having been acquired with a digital camera has been proposed in, for example, U.S. Pat. No. 6,011,547. With the proposed technique, information concerning an image recording operation, such as information representing a flashlight on-off state at the time of the image recording operation and information representing the kind of lighting at the time of the image recording operation, is appended as tag information to the image signal having been acquired with the digital camera, reference is made to the information concerning the image recording operation, which information is appended to the image signal, when the image signal is to be performed, and appropriate image processing is performed on the image signal in accordance with the information concerning the image recording operation.

Besides the information representing the flashlight on-off state at the time of the image recording operation and the information representing the kind of lighting at the time of the image recording operation, the tag information also contains various pieces of information useful for the image processing, such as information representing an image-recording magnification ratio, information representing an object distance, information representing an object luminance, information representing an exposure value, information representing photometric values, information representing whether the photograph was or was not taken against the light, and information representing a focusing point. Therefore, various techniques for performing image processing on image signals by use of the information concerning the image recording operation have been proposed in, for example, U.S. Pat. Nos. 5,016,039, 6,133,983, and 5,739,924, Japanese Unexamined Patent Publication Nos. 5(1993)-340804, 8(1996)-307767, and 11(1999)-88576.

The image signals having been acquired with the digital cameras are often subjected to the trimming with respect to a desired image region or the combining of an image signal with a template for forming a composed image. In cases where the trimming is to be performed or in cases where the combining with the template is to be performed, it is necessary for a desired image region to be extracted from the image. Techniques for extracting desired image regions from images have been proposed in, for example, Japanese Unexamined Patent Publication Nos. 2000-147635 and 2000-270198. With the technique proposed in Japanese Unexamined Patent Publication No. 2000-147635, in cases where an image signal and a template are to be combined with each other, it is assumed that a main object image pattern is embedded at a center area of an image, the position of the center area of the image is matched with a center position of the template, the size of the image is enlarged or reduced, and the desired image region is then extracted from the image. With the technique proposed in Japanese Unexamined Patent Publication No. 2000-270198, face image contour information is extracted from an image signal representing an image, in which a face image pattern is embedded, the size of the face image pattern is enlarged or reduced such that the face image pattern is located in a predetermined image region of the template, and the region of the face image pattern is then extracted from the image.

As described above, the region extracted from the image is the region, in which the main object image pattern embedded in the image is located. However, the region, in which the main object image pattern embedded in the image is located, is not necessarily limited to the center region of the image. Also, it often occurs that an object image pattern other than the face image pattern embedded in the image is to be extracted as the main object image pattern.

### SUMMARY OF THE INVENTION

The primary object of the present invention is to provide an image processing method, wherein a desired image region is capable of being extracted accurately from an image regardless of a kind of a main object image pattern and a position of the main object image pattern in the image.

Another object of the present invention is to provide an apparatus for carrying out the image processing method.

A further object of the present invention is to provide a computer program for causing a computer to execute the image processing method.

A still further object of the present invention is to provide a computer readable recording medium, on which the computer program has been recorded.

The present invention provides an image processing method, comprising the steps of:

i) acquiring information representing a position of a main object image pattern, which is embedded in an image represented by an image signal having been acquired with a digital camera, the information having been appended to the image signal,

ii) setting a predetermined image region, which contains the main object image pattern, on the image and in accordance with the information representing the position of the main object image pattern, and

iii) extracting the predetermined image region from the image.

As the information representing the position of the main object image pattern, tag information, which is appended to the image signal having been acquired with the digital camera, may be utilized. Specifically, for example, information representing coordinate values of a focusing point on the image represented by the image signal may be utilized as the information representing the position of the main object image pattern. Also, in cases where the image is divided into a plurality of regions, and numbers are given to the plurality of the regions, the information representing the number of a region, which contains the focusing point, may be utilized as the information representing the position of the main object image pattern.

Certain kinds of digital cameras are provided with functions for performing multi-point distance measurement. Each of image signals having been acquired with the digital cameras provided with the functions for performing the multi-point distance measurement represents the image containing a plurality of focusing points. Therefore, each of the image signals having been acquired with the digital cameras described above is appended with a plurality of pieces of information as the information representing the position of the main object image pattern. Also, certain kinds of digital cameras are provided with functions for manually specifying the position of the main object and containing the information, which represents the specified position, as the information representing the position of the main object image pattern in the tag information. The information representing the position of the main object image pattern, which information is appended to each of the image signals having been acquired with the digital cameras described above, is the information having been specified manually.

Further, in cases where the focus of the lens of the digital camera is adjusted and locked, and the image recording range is then shifted, the focusing point becomes shifted within the image recording range. In such cases, information representing the position of the focusing point after being shifted is appended as the information, which represents the position of the main object image pattern, to the image signal.

The term “tag information” as used herein means the information, which is appended to the image signal having been acquired with the digital camera. Examples of standards for the tag information include “Baseline TIFF Rev. 6.0.0 RGB Full Color Image” employed as a non-compressed file of an Exif file.

The image processing method in accordance with the present invention may be modified such that information concerning an image-recording magnification ratio at the time of the acquisition of the image signal, which information has been appended to the image signal, is also acquired, and

the setting of the predetermined image region is performed also in accordance with the information concerning the image-recording magnification ratio.

The information concerning the image-recording magnification ratio may be the information representing the image-recording magnification ratio itself. Alternatively, the information concerning the image-recording magnification ratio may be the information, from which the image-recording magnification ratio is capable of being presumed, such as the information representing the object distance and/or the focal length.

Also, the image processing method in accordance with the present invention may be modified such that the predetermined image region and a template are combined with each other, and a composed image is thereby formed.

Further, the image processing method in accordance with the present invention may be modified such that a size of the predetermined image region is enlarged or reduced in accordance with a size of an image inserting region of the template.

The present invention also provides an image processing apparatus, comprising:

i) information acquiring means for acquiring information representing a position of a main object image pattern, which is embedded in an image represented by an image signal having been acquired with a digital camera, the information having been appended to the image signal,

ii) region setting means for setting a predetermined image region, which contains the main object image pattern, on the image and in accordance with the information representing the position of the main object image pattern, and

iii) extraction means for extracting the predetermined image region from the image.

The image processing apparatus in accordance with the present invention may be modified such that the information acquiring means also acquires information concerning an image-recording magnification ratio at the time of the acquisition of the image signal, which information has been appended to the image signal, and

the region setting means performs the setting of the predetermined image region also in accordance with the information concerning the image-recording magnification ratio.

Also, the image processing apparatus in accordance with the present invention may be modified such that the apparatus further comprises image composing means for combining the predetermined image region and a template with each other in order to form a composed image.

Further, the image processing apparatus in accordance with the present invention may be modified such that the image composing means enlarges or reduces a size of the predetermined image region in accordance with a size of an image inserting region of the template.

The present invention further provides a computer program for causing a computer to execute the image processing method in accordance with the present invention.

The present invention still further provides a computer readable recording medium, on which the computer program has been recorded.

A skilled artisan would know that the computer readable recording medium is not limited to any specific type of storage devices and includes any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of the present invention. Additionally, computer code/instructions include, but are not limited to, source, object, and executable code and can be in any language including higher level languages, assembly language, and machine language.

With the image processing method and apparatus in accordance with the present invention, the predetermined image region, which contains the main object image pattern, is set on the image, which is represented by the image signal, and in accordance with the information representing the position of the main object image pattern, which information has been appended to the image signal. Also, the predetermined image region having thus been set is extracted from the image. Therefore, in cases where the main object image pattern is located at a position other than the center area of the image, and in cases where the main object image pattern is an image pattern other than a person's face image pattern, the predetermined image region, which contains the main object image pattern, is capable of being extracted from the image.

With the image processing method and apparatus in accordance with the present invention, the setting of the predetermined image region may be performed also in accordance with the information concerning the image-recording magnification ratio. In such cases, the predetermined image region is capable of being set and extracted in accordance with the size of the main object image pattern, which size varies in accordance with the image-recording magnification ratio.

The image processing method and apparatus in accordance with the present invention may be modified such that the predetermined image region and the template are combined with each other into the composed image. With the modification described above, in cases where the main object image pattern is located at a position other than the center area of the image, and in cases where the main object image pattern is an image pattern other than a person's face image pattern, the predetermined image region having been extracted from the image, which region contains the main object image pattern, is capable of being combined with the template.

In the modification described above, the size of the predetermined image region may be enlarged or reduced in accordance with the size of the image inserting region of the template. In such cases, the composed image is capable of being obtained such that the size of the main object image pattern conforms to the size of the image inserting region of the template.

### BRIEF DESCRIPTION OF THE DRAWINGS

FIG. 1 is a block diagram showing a first embodiment of the image processing apparatus in accordance with the present invention,

FIG. 2 is an explanatory view showing how an image is divided into a plurality of regions, and numbers are given to the plurality of the regions,

FIG. 3A is an explanatory view showing an example of a template,

FIG. 3B is an explanatory view showing an example of an image represented by an image signal,

FIG. 3C is an explanatory view showing an example of how an image region to be extracted from the image of FIG. 3B is set on the image,

FIG. 4 is a flow chart showing how the first embodiment of the image processing apparatus in accordance with the present invention operates,

FIG. 5 is a block diagram showing a second embodiment of the image processing apparatus in accordance with the present invention, and

FIG. 6 is a flow chart showing how the second embodiment of the image processing apparatus in accordance with the present invention operates.

### DESCRIPTION OF THE PREFERRED EMBODIMENTS

The present invention will hereinbelow be described in further detail with reference to the accompanying drawings.

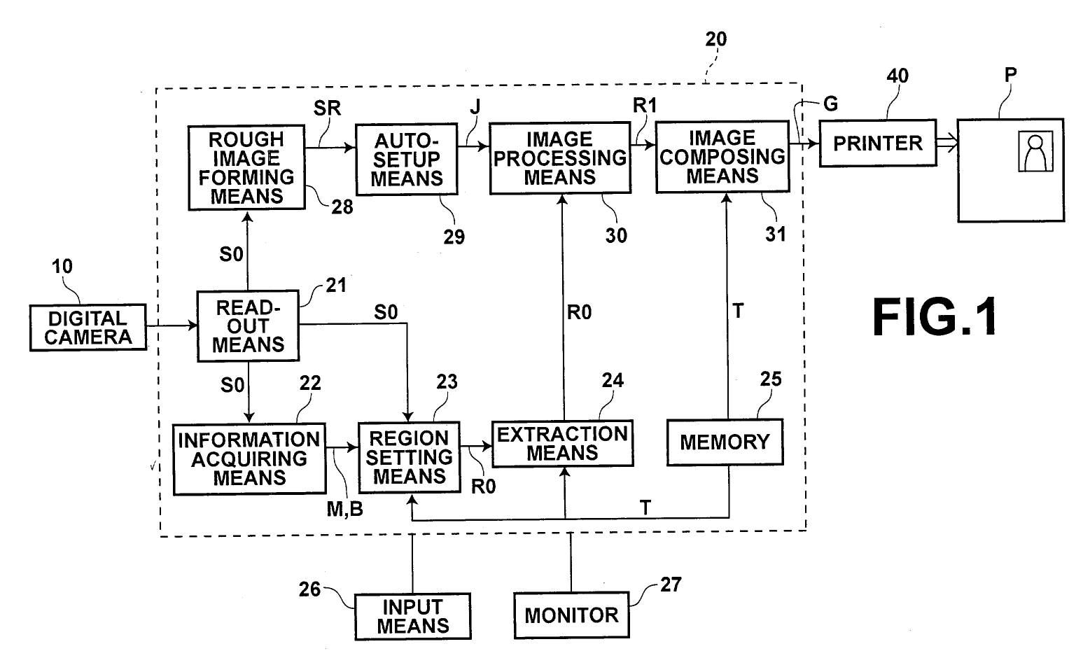

FIG. 1 is a block diagram showing a first embodiment of the image processing apparatus in accordance with the present invention. As illustrated in FIG. 1, an image processing apparatus 20, which is the first embodiment of the image processing apparatus in accordance with the present invention, reads out an image signal S0 having been acquired from an object image recording operation performed with a digital camera 10 and extracts an image region, which contains a main object image pattern, from the image represented by the image signal S0. Also, the image processing apparatus 20 combines the thus extracted image region and a template with each other in order to form a composed image. A composed image signal representing the composed image is fed into a printer 40. The printer 40 outputs a print P of the composed image in accordance with the composed image signal having been received.

As illustrated in FIG. 1, the image processing apparatus 20 comprises read-out means 21 for reading out the image signal S0, which has been acquired with the digital camera 10, from a recording medium, such as a memory card, on which the image signal S0 has been recorded. The image processing apparatus 20 also comprises information acquiring means 22 for acquiring information M representing the position of the main object image pattern, which information is contained in tag information having been appended to the image signal S0, and information B concerning an image-recording magnification ratio, which information is contained in tag information having been appended to the image signal S0. The image processing apparatus 20 further comprises region setting means 23 for setting an image region R0, which contains the main object image pattern, on the image represented by the image signal S0. (The image represented by the image signal S0 will hereinbelow be referred to simply as the image and represented by S0 as in the cases of the image signal S0.) The setting of the image region R0 is performed in accordance with the information M representing the position of the main object image pattern and the information B concerning the image-recording magnification ratio. The image processing apparatus 20 still further comprises extraction means 24 for extracting the set image region R0 from the image S0 and acquiring region image signal components representing the image region R0. (The region image signal components representing the image region R0 will hereinbelow be represented by R0 as in the cases of the image region R0.) The image processing apparatus 20 also comprises a memory 25 for storing a template signal representing a template T. (The template signal representing the template T will hereinbelow be represented by T as in the cases of the template T.)

The image processing apparatus 20 further comprises input means 26 for receiving various inputs. The image processing apparatus 20 still further comprises a monitor 27 for displaying various pieces of information. The image processing apparatus 20 also comprises rough image forming means 28 for decreasing the number of pixels in the image, which is represented by the image signal S0, in order to form a rough image signal SR. The image processing apparatus 20 further comprises auto-setup means 29 for setting gradation processing conditions for the region image signal components R0, transform conditions for image density transform and color transform, which are to be performed on the region image signal components R0, and sharpness processing conditions for sharpness processing, which is to be performed on the region image signal components R0, as image processing conditions J. The setting of the image processing conditions J is performed in accordance with the rough image signal SR. The image processing apparatus 20 still further comprises image processing means 30 for performing image processing on the region image signal components R0 in accordance with the image processing conditions J in order to obtain processed region image signal components R1. The image processing apparatus 20 also comprises image composing means 31 for combining the template T and the processed region image, which is represented by the processed region image signal components R1, with each other in order to obtain a composed image signal G representing a composed image. (The processed region image, which is represented by the processed region image signal components R1, will hereinbelow be represented by R1 as in the cases of the processed region image signal components R1. Also, the composed image will hereinbelow be represented by G as in the cases of the composed image signal G.)

The information acquiring means 22 acquires the information M representing the position of the main object image pattern, which information has been appended to the image signal S0, and the information B concerning the image-recording magnification ratio, which information has been appended to the image signal S0. The information M representing the position of the main object image pattern and the information B concerning the image-recording magnification ratio have been appended as the tag information to the image signal S0.

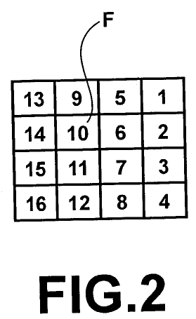

By way of example, as the information M representing the position of the main object image pattern, information representing coordinate values of a focusing point on the image S0, which information has been appended as the tag information to the image signal S0, may be utilized. As illustrated in FIG. 2, in cases where the image S0 is divided into a plurality of regions, and numbers are given to the plurality of the regions, information representing the number of a region, which contains the focusing point, has been appended as the tag information to the image signal S0 by the digital camera 10. Therefore, in such cases, the information representing the number of the region, which contains the focusing point, is utilized as the information M representing the position of the main object image pattern. For example, as illustrated in FIG. 2, in cases where a focusing point F is located within a region of a number 10, the information representing the number 10 is utilized as the information M representing the position of the main object image pattern.

A certain kind of digital camera 10 may be provided with functions for performing multi-point distance measurement. In such cases, the image signal S0 having been acquired with the digital camera 10 provided with the functions for performing the multi-point distance measurement represents the image containing a plurality of focusing points. Therefore, the image signal S0 having been acquired with the digital camera 10 described above is appended with a plurality of pieces of information as the information M representing the position of the main object image pattern. In such cases, the plurality of pieces of information are acquired as the information M representing the position of the main object image pattern from the tag information appended to the image signal S0. Therefore, the image represented by the image signal S0 may be displayed on the monitor 27, and the focusing point to be utilized for the image composition may be selected by the operator.

Also, a certain kind of digital camera 10 may be provided with functions for manually specifying the position of the main object and containing the information, which represents the specified position, as the information M representing the position of the main object image pattern in the tag information. The information M representing the position of the main object image pattern, which information is appended to the image signal S0 having been acquired with the digital camera 10 described above, is the information having been specified manually as the tag information.

Further, in cases where the focus of the lens of the digital camera 10 is adjusted and locked, and the image recording range is then shifted, the focusing point becomes shifted within the image recording range. In such cases, information representing the position of the focusing point after being shifted is appended as the information M, which represents the position of the main object image pattern, to the image signal S0.

The information B concerning the image-recording magnification ratio is the information concerning the image-recording magnification ratio, which is set at the time of the image recording operation. In this embodiment, information representing an object distance, which information is contained in the tag information, is acquired as the information B concerning the image-recording magnification ratio. Alternatively, information representing a focal length, which information is contained in the tag information, may be acquired as the information B concerning the image-recording magnification ratio.

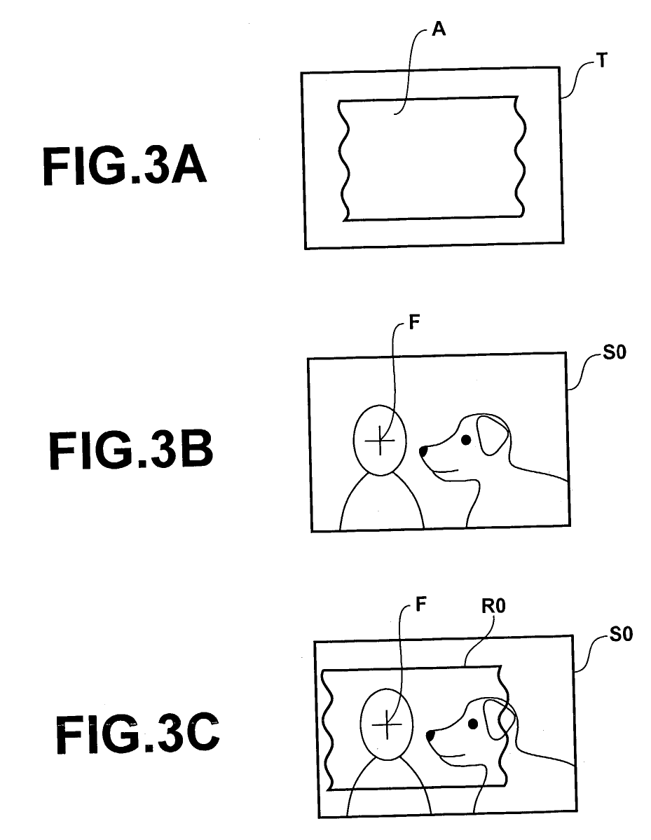

The region setting means 23 sets the image region R0, which is to be extracted, on the image S0 and in accordance with the information M representing the position of the main object image pattern and the information B concerning the image-recording magnification ratio. In order for the image region R0 to be set, the shape and the size of an image inserting region of the template T to be used for the image composition are taken into consideration. Specifically, the image region R0 having a shape conforming to the shape of the image inserting region of the template T is set on the image S0 and in accordance with the information M representing the position of the main object image pattern, such that a center point of the main object image pattern may be located at a center area of the image inserting region of the template T. For example, as illustrated in FIG. 3A, the template T may have an image inserting region A. Also, as illustrated in FIG. 3B, the focusing point of the image S0 may be located at a position F. In such cases, as illustrated in FIG. 3C, the image region R0 is set such that the focusing point may be located at the center area of the image inserting region A of the template T.

The image region R0 having been set in the manner described above is displayed on the monitor 27 in a state in which the image region R0 is temporarily combined with the template T.

In cases where the image region R0 is set such that the focusing point is located at the center area of the image inserting region A of the template T, it may often occur that an end area of the image S0 appears within the image inserting region A of the template T. In such cases, at the time at which the template T and the processed region image R1 are to be combined with each other as will be described later, the size of the processed region image R1 may be enlarged.

Alternatively, the operator may visually make a judgment on the temporary composed image, which is displayed on the monitor 27, and as to whether an end area of the image S0 appears or does not appear within the image inserting region A of the template T. In cases where the end area of the image S0 appears within the image inserting region A, the operator may enlarge the size of the image region R0 or may again set the image region R0.

The information B concerning the image-recording magnification ratio is utilized for the setting of the size of the image region R0. For example, in cases where the value of the object distance acting as the information B concerning the image-recording magnification ratio is smaller than a predetermined threshold value, it may be regarded that the main object image pattern is embedded with a comparatively large size in the image S0. Therefore, in such cases, the image region R0 is set such that the main object image pattern may be contained with a comparatively large size within the image inserting region A of the template T.

In cases where the value of the object distance acting as the information B concerning the image-recording magnification ratio is not smaller than the predetermined threshold value, it may be regarded that background areas around the main object image pattern are also important. Therefore, in such cases, the image region R0 is set such that both the main object image pattern and the background areas around the main object image pattern may be contained within the image inserting region A of the template T. In such cases, in order for the size of the image region R0 to be set, it is taken into consideration that the image size will be enlarged or reduced at the time of image composition.

Alternatively, after the temporary composed image is formed by combining the image region R0 and the template T with each other and displayed on the monitor 27, the operator may see the temporary composed image and may again set the size of the image region R0.

As another alternative, the size of a person's face image pattern embedded in the image S0 may be detected in accordance with the information B concerning the image-recording magnification ratio, and the size of the image region R0 may be set in accordance with the size of the face image pattern. The size of the face image pattern may be calculated with Formula (1) shown below. In such cases, the image region R0 is subjected to the image size enlargement or reduction processing at the time of the image composition. The image size enlargement or reduction processing on the image region R0 should preferably be performed such that the ratio of the size of the image inserting region A, which size is taken in the vertical direction, to the size of the face image pattern becomes equal to a predetermined value (e.g., 3). The information representing a focal length f is contained in the tag information and is acquired as the information B concerning the image-recording magnification ratio.

Fs=Fs0×f/(L−f) (1)

wherein Fs represents the size of the face image pattern, Fs0 represents the size of the reference face image pattern, f represents the focal length, and L represents the object distance.

The extraction means 24 extracts the image region R0, which has been set, from the image S0 and acquires the region image signal components R0.

The memory 25 stores a plurality of template signals T, T, . . . The template T, which is to be combined with the image region R0 having been extracted, is selected in accordance with an instruction, which is specified by the operator from the input means 26. The template signal T representing the selected template T is read out from the memory 25.

The rough image forming means 28 thins out the image S0 at intervals of several pixels and thereby forms the rough image signal SR representing the rough image.

The auto-setup means 29 sets the gradation processing conditions, the image density transform conditions, the color transform conditions, and sharpness processing conditions. The setting of the processing conditions is performed in accordance with the rough image signal SR. The processing conditions, which have thus been set, are fed as the image processing conditions J into the image processing means 30.

The image processing means 30 performs the image processing on the region image signal components R0 in accordance with the image processing conditions J in order to obtain the processed region image signal components R1.

The image composing means 31 combines the template T and the processed region image R1 with each other by inserting the processed region image R1 into the image inserting region A of the template T. In this manner, the image composing means 31 obtains the composed image signal G representing the composed image.

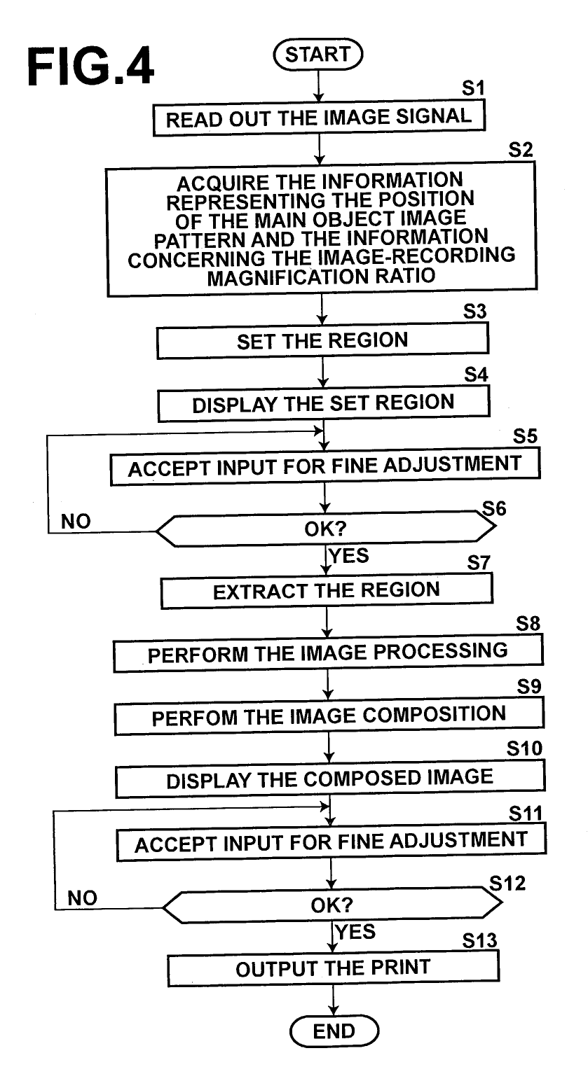

How the first embodiment of the image processing apparatus in accordance with the present invention operates will be described hereinbelow. FIG. 4 is a flow chart showing how the first embodiment of the image processing apparatus in accordance with the present invention operates. In this case, the rough image signal SR has already been formed by the rough image forming means 28, and the image processing conditions J have already been set by the auto-setup means 29 and in accordance with the rough image signal SR. Also, the template T to be utilized for the image composition has already been selected.

Firstly, in a step S1, the image signal S0 is read out by the read-out means 21. The image signal S0 is fed into the information acquiring means 22. In a step S2, the information M representing the position of the main object image pattern and the information B concerning the image-recording magnification ratio are acquired by the information acquiring means 22. The information M representing the position of the main object image pattern and the information B concerning the image-recording magnification ratio are fed into the region setting means 23 together with the image signal S0. In a step S3, the image region R0 containing the main object image pattern is set by the region setting means 23 with the shape and the size of the image inserting region A of the template T being taken into consideration.

In a step S4, the image region R0 having been set is displayed on the monitor 27. When necessary, in a step S5, the operator performs fine adjustments, such as re-setting of the image region R0 and alteration of the size of the image region R0. In order for the fine adjustments to be performed, the operator specifies instructions from the input means 26. In a step S6, the operator specifies an instruction, which represents whether the setting of the image region R0 is or is not OK, from the input means 26. In cases where the operator specifies the instruction, which represents that the setting of the image region R0 is OK, in a step S7, the image region R0 is extracted from the image S0. In cases where, in the step S6, the operator specifies the instruction, which represents that the setting of the image region R0 is not OK, the procedure is returned to the step S5, and the processing in the step S5 and the processing in the step S6 are iterated.

The region image signal components R0, which represent the extracted image region R0, are fed into the image processing means 30. In a step S8, the image processing is performed on the region image signal components R0 and in accordance with the image processing conditions J, and the processed region image signal components R1 are acquired. The processed region image signal components R1 are fed into the image composing means 31. In a step S9, the processed region image R1 and the template T are combined with each other, and the composed image G is acquired.

In a step S10, the composed image G is displayed on the monitor 27. When necessary, in a step S11, the operator performs fine adjustments, such as re-setting of the image region R0 and alteration of the size of the image region R0. In order for the fine adjustments to be performed, the operator specifies instructions from the input means 26. In a step S12, the operator specifies an instruction, which represents whether the setting of the image region R0 is or is not OK, from the input means 26. In cases where the operator specifies the instruction, which represents that the setting of the image region R0 is OK, in a step S13, the print of the composed image G is outputted by the printer 40. At this stage, the processing is finished. In cases where, in the step S12, the operator specifies the instruction, which represents that the setting of the image region R0 is not OK, the procedure is returned to the step S11, and the processing in the step S11 and the processing in the step S12 are iterated.

As described above, with the first embodiment of the image processing apparatus in accordance with the present invention, the image region R0, which contains the main object image pattern, is set on the image S0 and in accordance with the information M representing the position of the main object image pattern, which information has been appended to the image signal S0. Also, the image region R0 having thus been set is extracted from the image S0. Therefore, in cases where the main object image pattern is located at a position other than the center area of the image S0, and in cases where the main object image pattern is an image pattern other than the person's face image pattern, the image region R0, which contains the main object image pattern, is capable of being extracted from the image S0.

Also, with the first embodiment described above, the setting of the image region R0 is performed also in accordance with the information B concerning the image-recording magnification ratio. Therefore, the image region R0 is capable of being set and extracted in accordance with the size of the main object image pattern, which size varies in accordance with the image-recording magnification ratio.

Further, with the first embodiment described above, the image region R0 and the template T are combined with each other into the composed image G. Therefore, in cases where the main object image pattern is located at a position other than the center area of the image, and in cases where the main object image pattern is an image pattern other than the person's face image pattern, the image region R0 having been extracted from the image S0, which image region contains the main object image pattern, is capable of being combined with the template T.

In such cases, the size of the image region R0 is enlarged or reduced in accordance with the size of the image inserting region A of the template T. Therefore, the composed image G is capable of being obtained such that the size of the main object image pattern conforms to the size of the image inserting region A of the template T.

In the first embodiment described above, in cases where a template T having a plurality of image inserting regions A, A, . . . is utilized, a plurality of image signals S0, S0, . . . are read out by the read-out means 21. Also, in such cases, the setting of the image region R0 is performed in the same manner as that described above and in accordance with the information M representing the position of the main object image pattern and the information B concerning the image-recording magnification ratio, and a composed image G is formed. In cases where a plurality of pieces of information are appended as the information M, which represents the position of the main object image pattern, to the image signal S0, the image region R0 having been extracted in accordance with the plurality of pieces of information appended as the information M, which represents the position of the main object image pattern, may be utilized for the combining with the template T having the plurality of the image inserting regions A, A, . . .

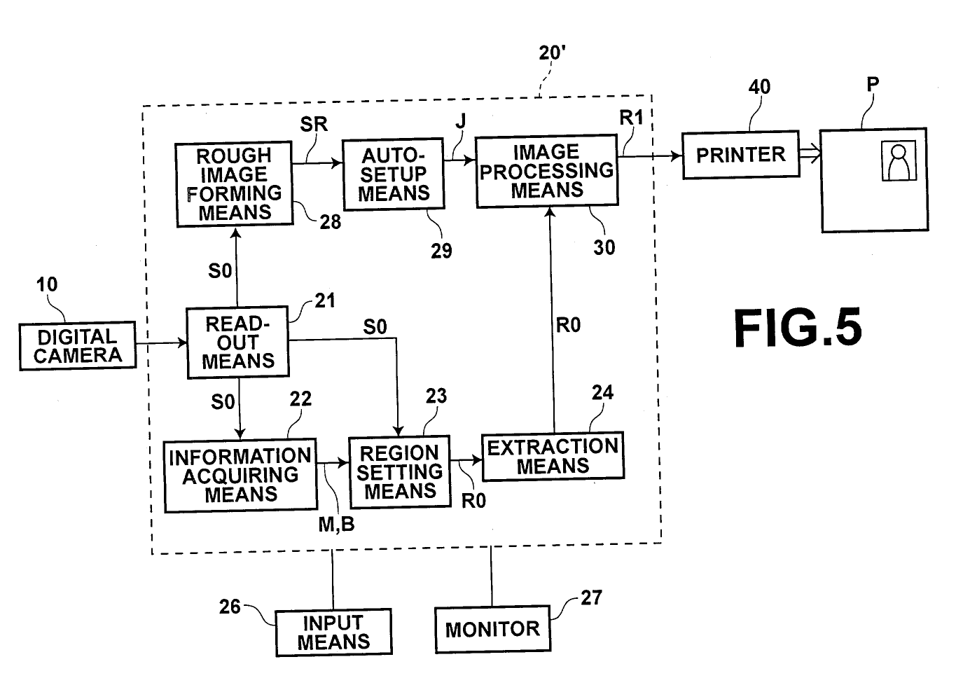

A second embodiment of the image processing apparatus in accordance with the present invention will be described hereinbelow. FIG. 5 is a block diagram showing the second embodiment of the image processing apparatus in accordance with the present invention. In FIG. 5, similar elements are numbered with the same reference numerals with respect to FIG. 1. As described above, in the first embodiment described above, the image region R0 having been set is extracted and combined with the template T, and the composed image G is thereby formed. However, in the second embodiment, only the extraction of the image region R0 having been set is performed, i.e. the trimming is performed. Therefore, in the second embodiment, in lieu of the image processing apparatus 20 employed in the first embodiment described above, an image processing apparatus 20′, which is not provided with the memory 25 and the image composing means 31, is employed.

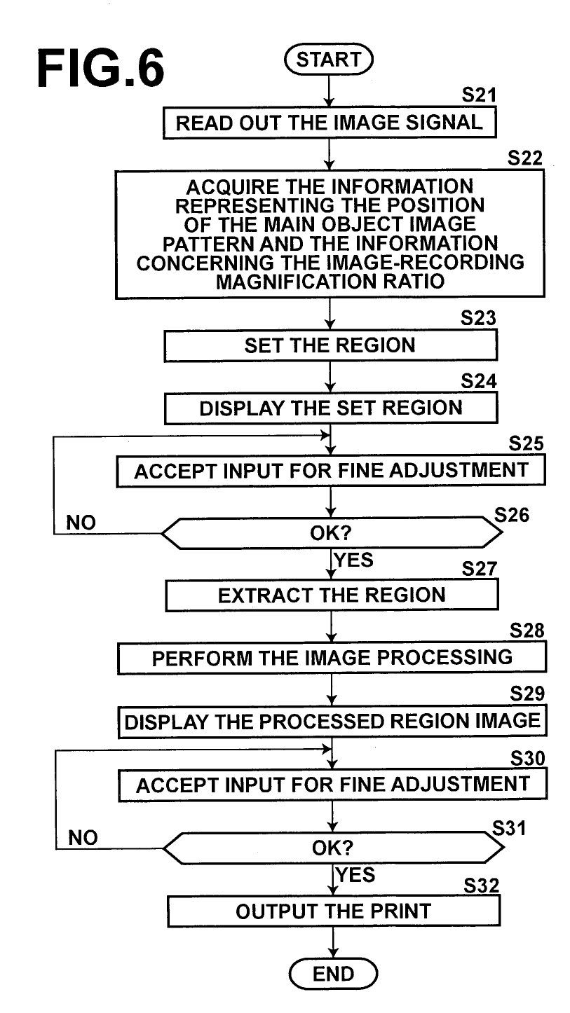

How the second embodiment of the image processing apparatus in accordance with the present invention operates will be described hereinbelow. FIG. 6 is a flow chart showing how the second embodiment of the image processing apparatus in accordance with the present invention operates. In this case, the rough image signal SR has already been formed by the rough image forming means 28, and the image processing conditions J have already been set by the auto-setup means 29 and in accordance with the rough image signal SR.

Firstly, in a step S21, the image signal S0 is read out by the read-out means 21. The image signal S0 is fed into the information acquiring means 22. In a step S22, the information M representing the position of the main object image pattern and the information B concerning the image-recording magnification ratio are acquired by the information acquiring means 22. The information M representing the position of the main object image pattern and the information B concerning the image-recording magnification ratio are fed into the region setting means 23 together with the image signal S0. In a step S23, the image region R0 containing the main object image pattern is set by the region setting means 23. In the second embodiment, wherein the trimming is to be performed, the size of the image region R0 is set in accordance with the size of the print P and a trimming magnification ratio. Specifically, after the center point of the image region R0 has been determined, the size of the image region R0 is set in accordance with the size of the print P and the trimming magnification ratio. In cases where only the size of the print P has been set, the trimming magnification ratio is set in accordance with the size of the print P and the center position of the image region R0, and the size of the image region R0 is thereby set.

In a step S24, the image region R0 having been set is displayed on the monitor 27. When necessary, in a step S25, the operator performs fine adjustments, such as re-setting of the image region R0 and alteration of the size of the image region R0. In order for the fine adjustments to be performed, the operator specifies instructions from the input means 26. In a step S26, the operator specifies an instruction, which represents whether the setting of the image region R0 is or is not OK, from the input means 26. In cases where the operator specifies the instruction, which represents that the setting of the image region R0 is OK, in a step S27, the image region R0 is extracted from the image S0. In cases where, in the step S26, the operator specifies the instruction, which represents that the setting of the image region R0 is not OK, the procedure is returned to the step S25, and the processing in the step S25 and the processing in the step S26 are iterated.

The region image signal components R0, which represent the extracted image region R0, are fed into the image processing means 30. In a step S28, the image processing is performed on the region image signal components R0 and in accordance with the image processing conditions J. At this time, when necessary, the image size enlargement or reduction processing is performed. In this manner, the processed region image signal components R1 are acquired. In a step S29, the processed region image R1 is displayed on the monitor 27. When necessary, in a step S30, the operator performs fine adjustments, such as re-setting of the image region R0 and alteration of the size of the image region R0. In order for the fine adjustments to be performed, the operator specifies instructions from the input means 26. In a step S31, the operator specifies an instruction, which represents whether the setting of the image region R0 is or is not OK, from the input means 26. In cases where the operator specifies the instruction, which represents that the setting of the image region R0 is OK, in a step S32, the print of the processed region image R1 is outputted by the printer 40. At this stage, the processing is finished. In cases where, in the step S31, the operator specifies the instruction, which represents that the setting of the image region R0 is not OK, the procedure is returned to the step S30, and the processing in the step S30 and the processing in the step S31 are iterated.

As described above, with the second embodiment of the image processing apparatus in accordance with the present invention, the image region R0, which contains the main object image pattern, is set on the image S0 and in accordance with the information M representing the position of the main object image pattern, which information has been appended to the image signal S0. Also, the image region R0 having thus been set is extracted from the image S0. Therefore, in cases where the main object image pattern is located at a position other than the center area of the image S0, and in cases where the main object image pattern is an image pattern other than the person's face image pattern, the image region R0, which contains the main object image pattern, is capable of being extracted from the image S0.

In the first and second embodiments described above, the setting of the image region R0 is performed in accordance with the information M representing the position of the main object image pattern and the information B concerning the image-recording magnification ratio. Alternatively, the setting of the image region R0 may be performed in accordance with only the information M representing the position of the main object image pattern.

What is claimed is:

1. An image processing method, comprising the steps of:
i) acquiring information representing a position of a main object image pattern, which is embedded in an image represented by an image signal having been acquired with a digital camera, the information having been appended to the image signal,
ii) setting a predetermined image region, which contains the main object image pattern, on the image and in accordance with the information representing the position of the main object image pattern, and
iii) extracting the predetermined image region from the image.

2. A method as defined in claim 1 wherein information concerning an image-recording magnification ratio at the time of the acquisition of the image signal, which information has been appended to the image signal, is also acquired, and
the setting of the predetermined image region is performed also in accordance with the information concerning the image-recording magnification ratio.

3. A method as defined in claim 1 wherein the predetermined image region and a template are combined with each other, and a composed image is thereby formed.

4. A method as defined in claim 2 wherein the predetermined image region and a template are combined with each other, and a composed image is thereby formed.

5. A method as defined in claim 3 wherein a size of the predetermined image region is enlarged or reduced in accordance with a size of an image inserting region of the template.

6. A method as defined in claim 4 wherein a size of the predetermined image region is enlarged or reduced in accordance with a size of an image inserting region of the template.

7. An image processing apparatus, comprising:
i) information acquiring means for acquiring information representing a position of a main object image pattern, which is embedded in an image represented by an image signal having been acquired with a digital camera, the information having been appended to the image signal,
ii) region setting means for setting a predetermined image region, which contains the main object image pattern, on the image and in accordance with the information representing the position of the main object image pattern, and
iii) extraction means for extracting the predetermined image region from the image.

8. An apparatus as defined in claim 7 wherein the information acquiring means also acquires information concerning an image-recording magnification ratio at the time of the acquisition of the image signal, which information has been appended to the image signal, and
the region setting means performs the setting of the predetermined image region also in accordance with the information concerning the image-recording magnification ratio.

9. An apparatus as defined in claim 7 wherein the apparatus further comprises image composing means for combining the predetermined image region and a template with each other in order to form a composed image.

10. An apparatus as defined in claim 8 wherein the apparatus further comprises image composing means for combining the predetermined image region and a template with each other in order to form a composed image.

11. An apparatus as defined in claim 9 wherein the image composing means enlarges or reduces a size of the predetermined image region in accordance with a size of an image inserting region of the template.

12. An apparatus as defined in claim 10 wherein the image composing means enlarges or reduces a size of the predetermined image region in accordance with a size of an image inserting region of the template.

13. A computer program for causing a computer to execute an image processing method, the computer program comprising the procedures for:
i) acquiring information representing a position of a main object image pattern, which is embedded in an image represented by an image signal having been acquired with a digital camera, the information having been appended to the image signal,
ii) setting a predetermined image region, which contains the main object image pattern, on the image and in accordance with the information representing the position of the main object image pattern, and
iii) extracting the predetermined image region from the image.

14. A computer program as defined in claim 13 wherein the computer program further comprises the procedure for acquiring information concerning an image-recording magnification ratio at the time of the acquisition of the image signal, which information has been appended to the image signal, and
the procedure for setting the predetermined image region is the procedure for performing the setting of the predetermined image region also in accordance with the information concerning the image-recording magnification ratio.

15. A computer program as defined in claim 13 wherein the computer program further comprises the procedure for combining the predetermined image region and a template with each other in order to form a composed image.

16. A computer program as defined in claim 14 wherein the computer program further comprises the procedure for combining the predetermined image region and a template with each other in order to form a composed image.

17. A computer program as defined in claim 15 wherein the computer program further comprises the procedure for enlarging or reducing a size of the predetermined image region in accordance with a size of an image inserting region of the template.

18. A computer program as defined in claim 16 wherein the computer program further comprises the procedure for enlarging or reducing a size of the predetermined image region in accordance with a size of an image inserting region of the template.

19. A computer readable recording medium, on which a computer program for causing a computer to execute an image processing method has been recorded and from which the computer is capable of reading the computer program,
wherein the computer program comprises the procedures for:
i) acquiring information representing a position of a main object image pattern, which is embedded in an image represented by an image signal having been acquired with a digital camera, the information having been appended to the image signal,
ii) setting a predetermined image region, which contains the main object image pattern, on the image and in accordance with the information representing the position of the main object image pattern, and
iii) extracting the predetermined image region from the image.

20. A computer readable recording medium as defined in claim 19 wherein the computer program further comprises the procedure for acquiring information concerning an image-recording magnification ratio at the time of the acquisition of the image signal, which information has been appended to the image signal, and
the procedure for setting the predetermined image region is the procedure for performing the setting of the predetermined image region also in accordance with the information concerning the image-recording magnification ratio.

21. A computer readable recording medium as defined in claim 19 wherein the computer program further comprises the procedure for combining the predetermined image region and a template with each other in order to form a composed image.

22. A computer readable recording medium as defined in claim 20 wherein the computer program further comprises the procedure for combining the predetermined image region and a template with each other in order to form a composed image.

23. A computer readable recording medium as defined in claim 21 wherein the computer program further comprises the procedure for enlarging or reducing a size of the predetermined image region in accordance with a size of an image inserting region of the template.

24. A computer readable recording medium as defined in claim 22 wherein the computer program further comprises the procedure for enlarging or reducing a size of the predetermined image region in accordance with a size of an image inserting region of the template.
